(19) United States
(12) Patent Application Publication
(10) Pub. No.: US 2010/0145635 A1
(43) Pub. Date: Jun. 10, 2010

(54) VANE TYPE FLOW METER WITH TWO OR MORE MEASURING RANGES

(75) Inventors: Abraham Pauncz, D.N. Misgav (IL); Uri Ben-Menachem, Netanya (IL); Eli Levy, Zafed (IL)

Correspondence Address: THE NATH LAW GROUP, 112 South West Street, Alexandria, VA, 22314, US

(73) Assignee: AQUA DIGITAL LTD., JORDAN VALLEY (IL)

(21) Appl. No.: 12/733,209

(22) PCT Filed: Dec. 3, 2008
(86) PCT No.: PCT/IL2008/001568

§ 371 Date: Feb. 17, 2010

Related U.S. Application Data
(60) Provisional application No. 60/996,721, filed on Dec. 3, 2007.
(60) Provisional application No. 61/129,470, filed on Jun. 30, 2008.

(51) Int. Cl. G01F 1/28

(52) U.S. Cl. 702/45

(57) ABSTRACT

A device for measurement of fluid flow in a conduit comprising a housing having an upstream end formed with a fluid inlet, a downstream end formed with a fluid outlet, a fluid flow path extending between the inlet port and the outlet port and having longitudinal axis, and one ore more flexible leaves fixedly mounted within the housing and extending into the fluid flow path, each having a leaf axis normal to a leaf plane, the one or more leaves being deformable responsive to fluid flow rate within the conduit. A measuring system for measuring deflection rate of each leaf responsive to fluid flow within the conduit and for generating a rate signal corresponding with the deflection rate, and a processor unit for processing the rate signal and converting it to an output signal indicative of fluid flow rate within the conduit.

### FIELD OF THE INVENTION

This invention relates to flow meters, in particular to digital flow meters for measuring a wide range of flow rates.

### BACKGROUND OF THE INVENTION

Many of the commonly used water meters use rotating parts and impellers to measure the velocity of fluid, or rotating pistons to measure the volume passing through the flow meter. Other commonly used flow meters that are relatively expensive and are typically used in the industrial or municipal applications are ultrasonic, electromagnetic, Curiolis, vortex, orifice flow meters and the like, suitable for generating a digital output.

Several examples of prior art flow meters are disclosed in the art. For example, U.S. Pat. No. 5,847,288 discloses a photo detector bending beam flow switch and flow meter uses the relative light output detector that is continuously modulated to produce a voltage output directly proportional to the rate of fluid flow past the target on a flow sensitive bending beam.

U.S. Pat. No. 4,989,456 discloses a variable area obstruction gas flow meter that uses an elastic membrane that includes three leaves that an increase in the flow rate increases the deflection of the leaves. The flow is measured with a differential pressure transducer according to orifice plate calculations.

U.S. Pat. No. 4,945,344 discloses an electro-optical slide that reflects the light source to a detector.

It has also been proposed to use a bending leaves as flow switches or flow indicators.

U.S. Pat. No. 4,931,776 discloses a metal strip vane that deflects and closes an electric contact at a preset flow rate.

U.S. Pat. No. 6,032,540 discloses a drag paddle disposed in the flow with a magnet on it. A second magnet interacts outside of the pipe rotates up or down depending on the flow rate.

U.S. Pat. No. 5,021,619 discloses a magnet carried of deflected beam comes close to a steam that has proximity switch or howl effect that changes with the magnet.

### SUMMARY OF THE INVENTION

It is an object of the present invention to provide a fluid flow meter competent of measuring a wide range of flow rates, i.e. substantially low flow rates and substantially high flow rates. The flow meter is an in-line type meter and is adapted to generate a digital signal indicative of the flow rate within a fluid conduit.

According to the present invention there is provided a fluid flow meter device for measurement of fluid flow in a conduit, said fluid flow meter comprising:
a housing having an upstream end formed with a fluid inlet, a downstream end formed with a fluid outlet, a fluid flow path extending between said inlet port and said outlet port and having longitudinal axis;
one ore more flexible leaves fixedly mounted within the housing and extending into said fluid flow path, each having a leaf axis normal to a leaf plane, the one or more leaves being deformable responsive to fluid flow rate within the conduit;
a measuring system for measuring a deflection rate of each leaf responsive to fluid flow within the conduit and for generating a rate signal corresponding with said deflection rate; and
a processor unit for processing said rate signal and converting it to an output signal indicative of fluid flow rate within said conduit.

Any one or more of the following configurations, designs and parameters may be incorporated in a fluid flow meter device, in accordance with the present invention:
the deflection rate is a deflection angle measured between the leaf axis and the longitudinal axis.
each of the one or more leaves is adapted to assume at least a first reference state corresponding to a predetermined position with respect to said longitudinal axis, representative of a first fluid flow condition within the conduit.
the deflection rate is a deflection pattern of a leaf.
two leafs are provided, a first of which having a first module of elasticity E₁ and the second leaf having a second module of elasticity E₂, wherein E₁<E₂, such that the first leaf is flexible responsive to substantially low flow rates and the second leaf is flexible to substantially high flow rates.
at least some of the leaves comprise a first portion having first parameters and a second portion having second parameters different of said first parameters by at least one parameter.
each leaf has a parameter different of parameters of at least part of other leaves by at least one parameter.
said at least one parameter is one of the following: an elasticity module, size, shape and a yield point.
at least one leaf support is provided, adapted for receiving therein of at least one leaf and preventing the leaf from breaking.
the one or more leaves are mounted in series along said longitudinal axis.
the leaves extend coaxial along the longitudinal axis, or coplanar.
the leaves are coplanar and are separately supported and are oriented facing each other.
the normal of the leaves in their first reference state is parallel to the longitudinal axis of the flow conduit.
the first reference state corresponds to the absence of flow within the conduit.
the measuring system comprises at least a first leaf having its deflection rate corresponding to a first flow rate and at least a second leaf having its deflection rate corresponding to a second flow rate, preferably the first flow rate is substantially low and the second flow rate is substantially high.
the measuring system comprises the first portion having a deflection rate corresponding to a substantially high flow rate and the second portion having a deflection rate corresponding to a substantially low flow rate.
the measuring system comprises an external coil and a leaf coil articulated to each one or more leaf, whereby voltage change is registered as a result of change in the deflection rate of each leaf.
each leaf is associated with a corresponding coil unit comprising a coil and a corresponding metallic element, the coil unit being external of the fluid flow and the metallic element being attached to the leaf, said coil changing its voltage emittance responsive to induction created by displacement of said metallic element.
the measuring system comprises an RF transmitter and an RF receiver.
the measuring system comprises a CCD camera adapted for reproducing images of the leafs indicative of their deflection rate.
the measuring system comprises an optical sensor attached to each leaf and adapted for producing a signal indicative of the deflection rate of each leaf.
the measuring system comprises strain gage attached to each leaf and adapted for producing a signal indicative of the deflection rate of each leaf.

### BRIEF DESCRIPTION OF THE DRAWINGS

In order to understand the invention and to see how it may be carried out in practice, embodiments will now be described, by way of non-limiting examples only, with reference to the accompanying drawings, in which:

FIG. 1A is an assembled isometric view of a flow meter according to one embodiment of the present invention;

FIG. 1B is an exploded isometric view of the flow meter shown in FIG. 1A.

FIG. 1C is a top view of a conduit constituting a part of the flow meter shown in FIGS. 1A and 1B;

FIG. 1D is a bottom isometric view of a cover of the conduit shown in FIG. 1C;

FIGS. 2A to 2C are cross-sectional isometric views illustrating of the flow meter shown in FIGS. 1A to 1D at the absence of flow, during low flow rate and during high flow rate, respectively;

FIGS. 3A to 3C are schematic side views illustrating a flow meter according to another embodiment of the present invention at the absence of flow, during low flow rate and during high flow rate, respectively;

FIGS. 4A to 4C are schematic side views illustrating a flow meter according to another embodiment of the present invention at the absence of flow, during low flow rate and during high flow rate, respectively;

FIG. 4D is a front view of leaves of the flow meter shown in FIGS. 3A to 3C;

FIG. 4E is a schematic sectioned view of the flow meter taken along line E-E in FIG. 4A;

FIG. 5 schematically illustrates a top view of a flow meter according to yet another embodiment of the present invention at the absence of flow;

FIGS. 6A to 6C schematically illustrate top views of a flow meter according to still another embodiment of the present invention at the absence of flow, during low flow rate and during high flow rate, respectively;

FIGS. 7A and 7C are schematic top and a side views, respectively, illustrating a flow meter according to another embodiment of the present invention;

FIG. 8 schematically illustrates an example of a measuring system used in conjunction with flow meters shown in FIGS. 1A to 7B;

FIG. 9 is a block diagram illustrating an example for an electrical circuit for use in the measuring system shown in FIG. 8;

FIG. 10 schematically illustrates another example of a measuring system for use with flow meters shown in FIGS. 1A to 7C;

FIG. 11 is block diagram illustrating an example for an electrical circuit for use in the measuring system shown in FIG. 10;

FIG. 12 schematically illustrates side view of a flow meter according to still another embodiment of the present invention during low flow rate and during high flow rate, respectively;

FIGS. 13A to 13C illustrate perspective, top and front views, respectively, of another example of a measuring system for use with flow meters shown in FIGS. 1A to 7B;

FIG. 14 is a block diagram illustrating an example for an electrical circuit for use in the measuring system shown in FIGS. 12A to 12C;

FIGS. 15A and 15B are side and top views, respectively, illustrating another example of a measuring system for use with flow meters shown in FIGS. 1A to 7B; and

FIG. 16 is a side view schematically illustrating another example of a measuring system for use with flow meters shown in FIGS. 1A to 7B.

### DETAILED DESCRIPTION OF EMBODIMENTS

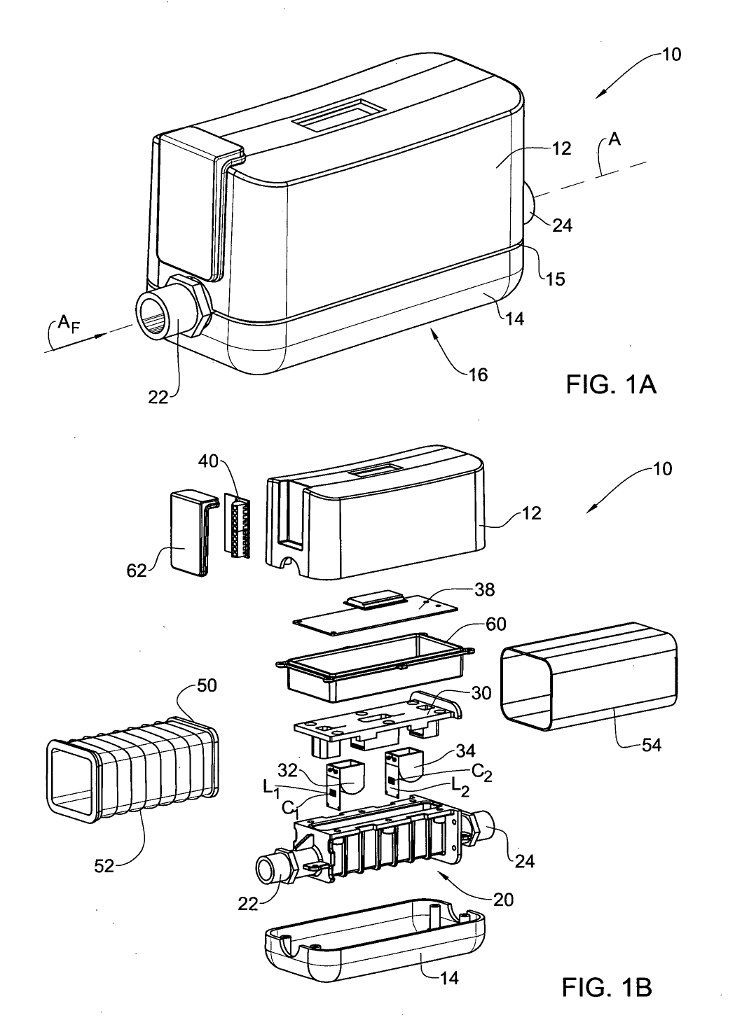

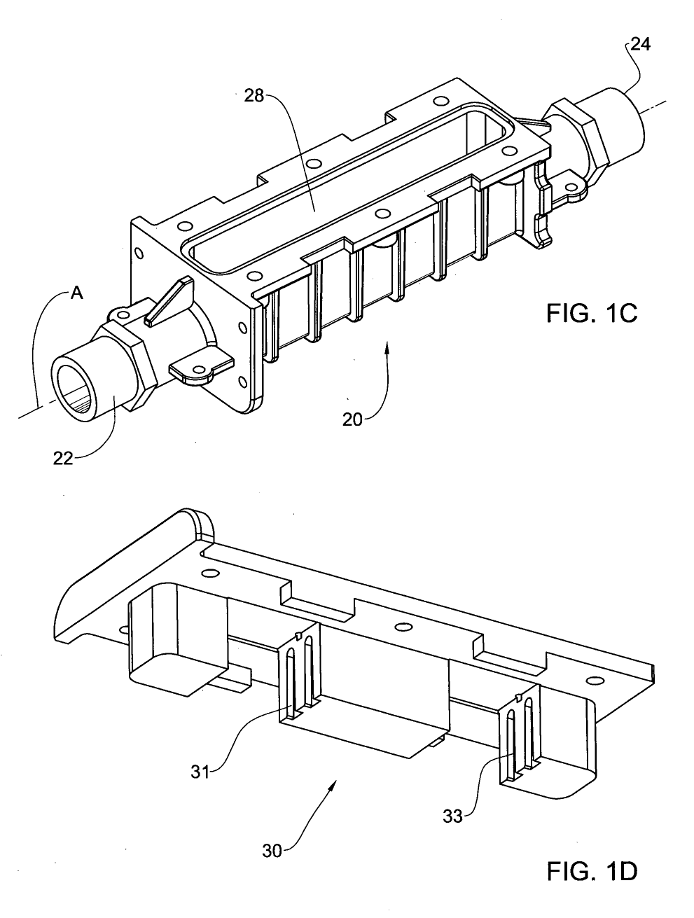

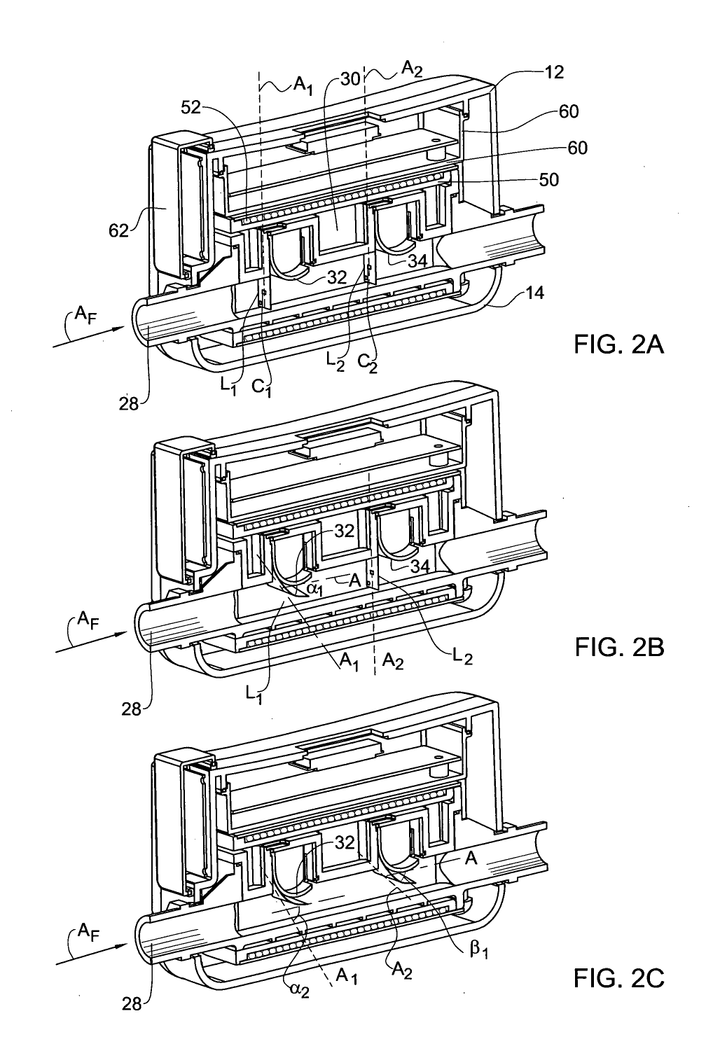

Attention is first directed to FIGS. 1A to 1D of the drawings illustrating an example of a flow meter in accordance with the present invention generally designated 10. The flow meter 10 comprises an external housing 16 composed of top member 12 and a base member 14 sealingly secured to one another about a seal member 15. As can further be seen in FIGS. 1B and 2 received within the housing 16 there is a conduit member generally designated 20 formed with an inlet port 22 and an outlet port 24, and which at the assembled position (FIG. 1A) project laterally from the housing 16, though in a fluid type manner. The conduit member 20 is formed with a conduit 28 (FIG. 1C) extending between the inlet port 22 and outlet port 24, defining a flow path therebetween having a central axis A. The conduit 28 is adapted to receive therein a fluid in a direction A_{F} parallel to the central axis, so that the inlet port 22 corresponds with an upstream side of the device and the outlet port 24 corresponds with a downstream side of the device. A conduit cover 30 is sealingly secured to the conduit member 20 (FIGS. 1B and 1D). The conduit cover 30 is provided with apertures 31 and 33 for receiving therein a first leave seat 32 (FIGS. 2A-2C) and a second leave seat 34, respectively. The leave seats 32 and 34 are fitted for fixedly supporting leaves L₁ and L₂ projecting into the conduit 28 such that the shape of each leaf substantially corresponds with the cross-sectional shape of the conduit 28 and generally extends, at the assembled position, such that edges of the respective leaves enable sidewalls of the conduit.

The leaves L₁ and L₂ are made of a flexible material whereupon applying fluid force thereon, along said flow path, they will deform in a downstream direction and however, upon seizing of the flow they will return to their initial position. The leaves may be made of a variety of materials, stating as an example a high yield stainless steel (Nirosta™ 301).

The arrangement is such that the leaves L₁ and L₂ are designed to deform differently under various flow conditions. In the present example, the first leave L₁ will deform under substantially low flow rates, (e.g. in the range at about 25-1500 LPH) whilst the second leave L₂ will deform under high flow rates (e.g. in the range at about 800-5000 LPH), whereby a substantially wide flow spectrum is covered.

The leaves L₁ and L₂ may obtain different elastic parameters for example by using different material or by imparting different mechanical parameters e.g. thickness, length, module of elasticity E etc.

The flow meter 10 comprises two on-board PCBs 38 and 40 respectively, mounted on the conduit cover 30, the first of which being articulated with the first and second leaves L₁ and L₂ for pick-up of electronic signals generated by electric coils C₁ and C₂, each articulated with the corresponding leaves L₁ and L₂, respectively. The second PCB 40 is associated with an external controller (not shown) and with the first PCB 38, and is covered by a second PCB cover 62.

The conduit member 20 is received within a coil core 50 with a coil 52 wound thereabout. A coil cover 54 is fitted over the coil 52 for protection thereof. The first PCB 38 mounted on the coil cover 54 and a first PCB cover 60 mounted over the PCB 38 encapsulating the structure.

The arrangement is such that deformation of the leaves L₁ and L₂ entails corresponding displacement of the coils C₁ and C₂, respectively, resulting in turn in generating an electric current through the coil 52 which is measurable by the first PCB 38, generating a flow signal corresponding to angles α₁ and β₁ of the deformation of the leaves (shown in FIGS. 2A to 2B), which in turn correspond with the different ranges of flow rate through the conduit 28. The angles α₁ and β₁ are defined between axes A₂ and A₂ and the axis A of the conduit 28.

The flow signal may also correspond to a deformation rate of the leaves, thus referred to as a rate signal, indicative of different flow rates.

Turning now to FIGS. 2A to 2C the flow meter 10 is illustrated in sectional views showing three flow conditions wherein FIG. 2A illustrates the flow meter 10 at rest i.e. at the absence of flow through the conduit 28; FIG. 2B illustrates the flow meter 10 during substantially low flow rate wherein the first leaf L₁ is deflected at an angle α₁ thereby generating a low flow rate signal and the second leaf L₂ remains substantially undeflected, and therefore perpendicular to the flow axis A, not generating any signal; FIG. 2C illustrates a position of substantially high flow rate wherein both leaves L₁ and L₂ are deflected at angles α₂ and β₁, respectively, the latter giving rise to a high flow rate signal.

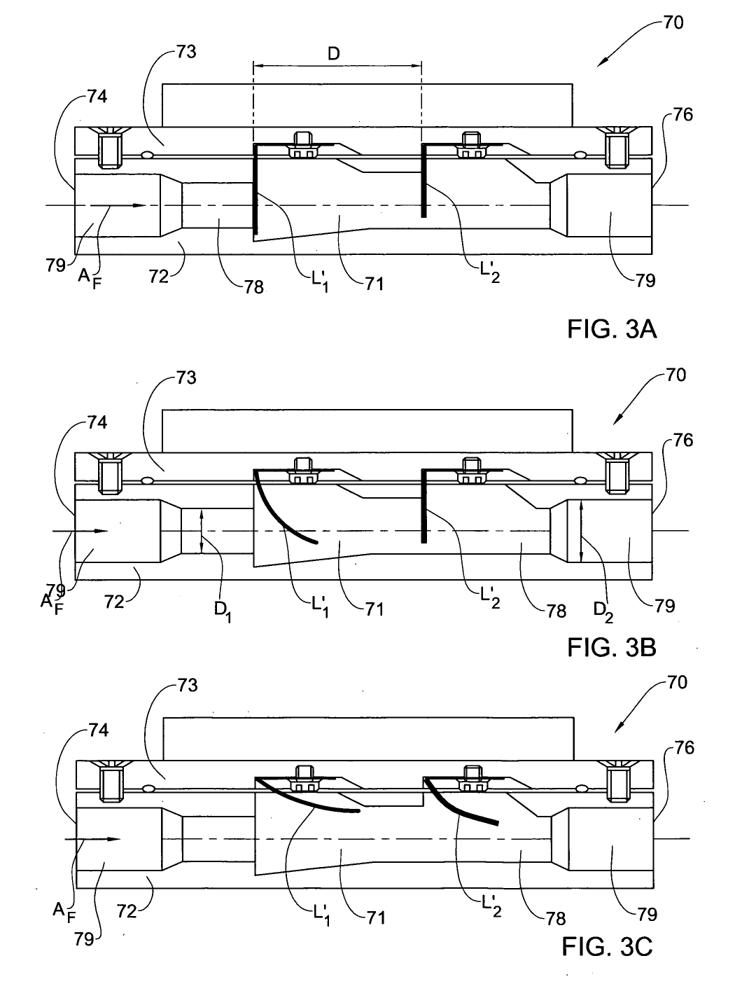

Turning now to FIGS. 3A-3C there is with illustrated another embodiment of the invention illustrating a flow meter designated 70 (for sake of clarity only the conduit member 72 is illustrated with the conduit cover 73). The conduit member 72 is formed with an inlet 74 and an outlet 76 and a conduit 78 extending therebetween. The conduit 78 has a central portion 77 which is narrower than its respective end portions 79, whereby their respective diameters satisfy that D₁<D₂ where D₁ is the diameter of the central portion 77 and D₂ is the diameter of the end portions 79. The central portion 77 of the conduit 78 has widened section 71 formed so as to allow displacement of leaves L₁′ and L₂′ therealong.

The leaves L₁′ and L₂′ are axially spaced at a distance D from one another, sufficient to avoid mutual interference therebetween. The first leaf L₁′ is thinner and longer than the second leaf L₂′ and thus responds to relatively lower flow rates in which case the second leaf L₂′ will remain substantially un-deformed (FIG. 3B). However, at high flow rates the second leaf L₂′ will deform as well (FIG. 3C), thus generating a corresponding signal.

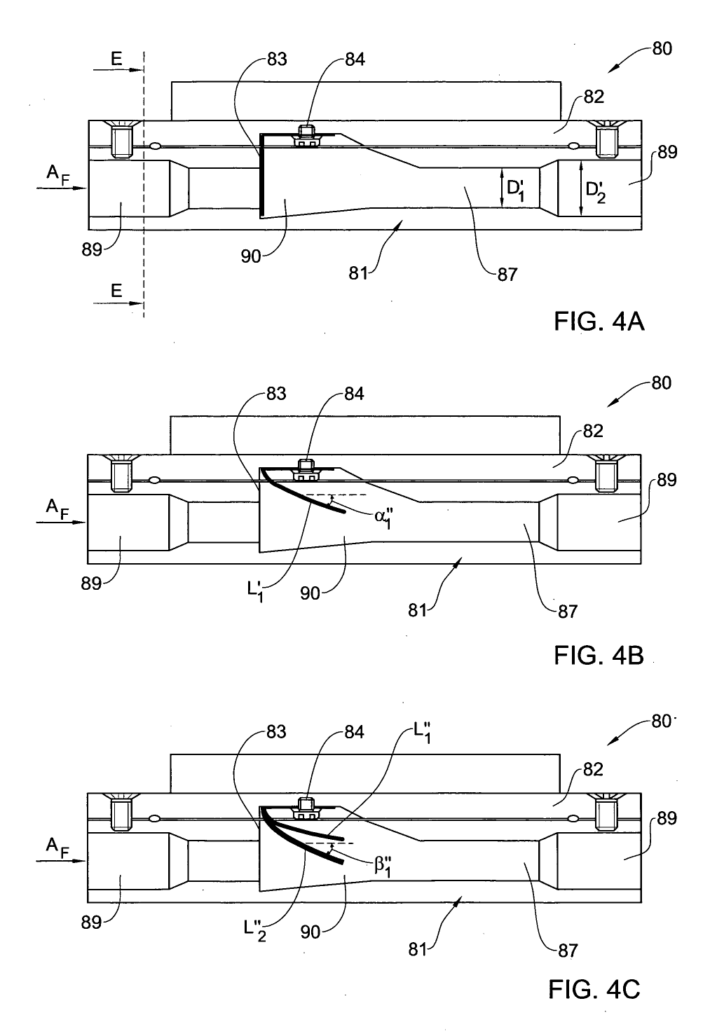

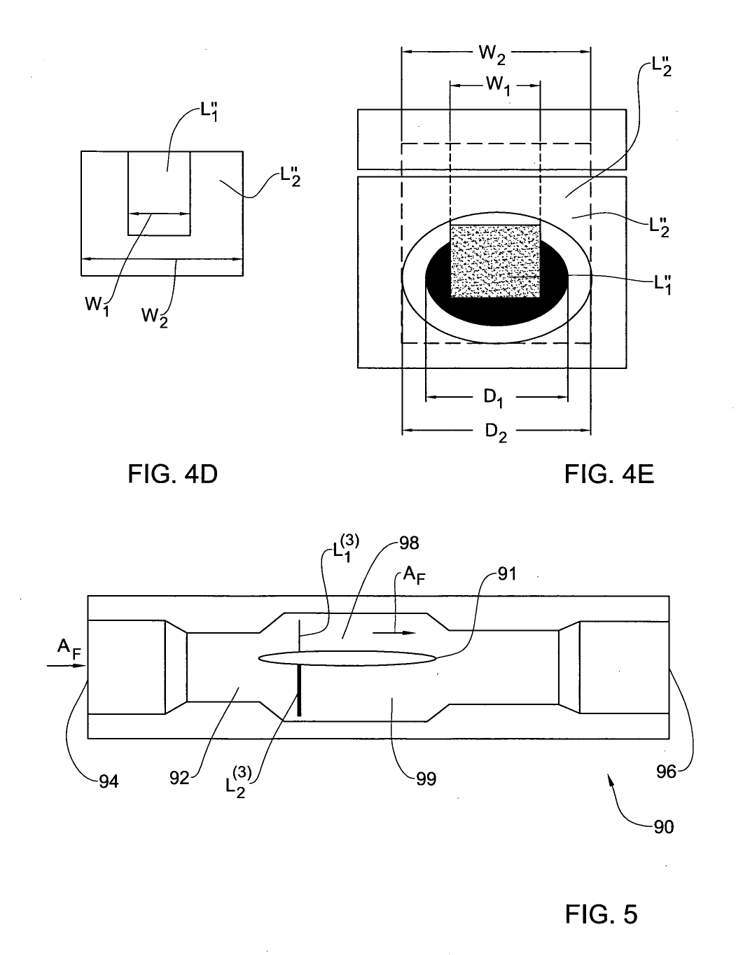

The embodiment of FIGS. 4A to 4E differs from the previous embodiment in that the two leaves L₁″ and L₂″ of the flow meter 80 are substantially co-planar (as opposed to the previous embodiments in which the leaves extend in series along the flow path). As can best be seen in FIGS. 4D and 4E the two leaves L₁″ and L₂″ are secured to the cover 82. This arrangement has the advantage of being more compact in the longitudinal dimension.

In the embodiment disclosed in FIGS. 4A to 4E, the conduit 81 is similar to the conduit 78 (FIGS. 3A to 3C) and the diameters of its portions satisfy that D₁′<D₂′ where D₁′ is the diameter of the central portion 87 and D₂′ is the diameter of the end portions 89. The central portion 87 of the conduit 81 has widened section 90 formed so as to allow displacement of the leaves L₁″ and L₂″ therealong. The first leaf L₁″ is a thin rectangle of width W₁ extending from a leaf seat 84 into the central portion 87 of the conduit 81 and the second leaf L₂″ is thicker than the first leaf L₁″ and has a substantially U-shape with its opening accommodating the first leaf L₁″ and having an external width W₂. The width W₁ of the first leaf L₁″ satisfies W₁<D₁′ and width W₂ of the second leaf L₂″ is substantially equal to the diameter D₂′ so as to substantially avoid head losses.

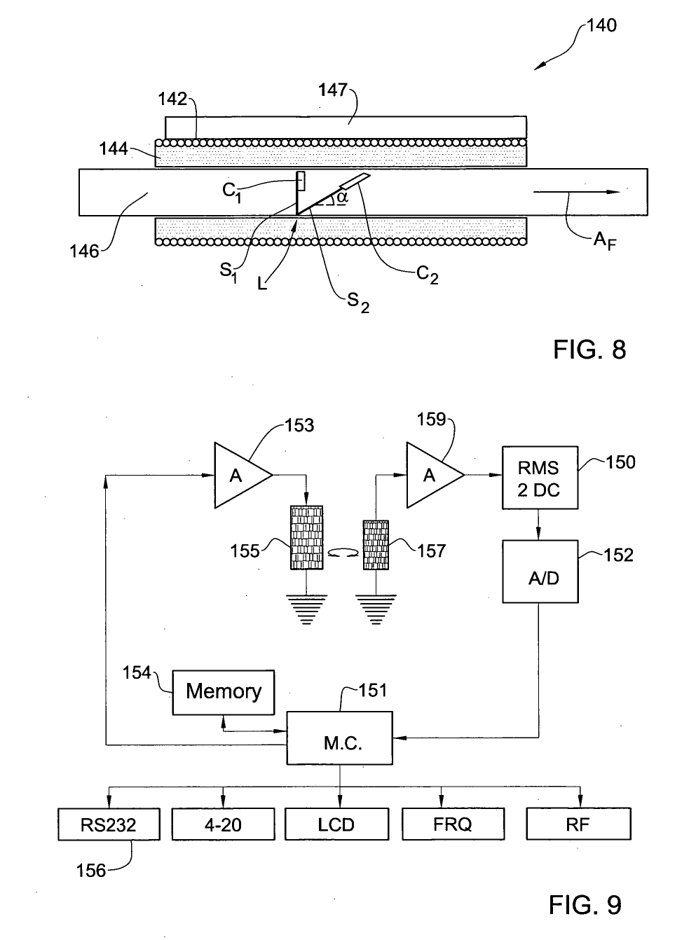

The signals related to angles α₁″ and β₁″ of the leaves L₁″ and L₂″, corresponding to substantially low and high flow rates, respectively, are measured by one of the measuring systems, as will be explained connection with FIGS. 8 to 15.

At the absence of flow (FIG. 4A) the co-planar leaves L₁″ and L₂″ bear against the conduit wall 83 thereby preventing back flow.

Turning now to FIG. 5 of the drawings, there is illustrated a flow meter generally designated 90 and comprising a conduit 92 extending between an inlet 94 and an outlet 96, said conduit 92 being split into two parallel sub-flow paths 98 and 99 by an isle member 91. A first leaf L₁⁽³⁾ is fixedly fitted within the narrower path 98 and second leaf L₂⁽³⁾ is fixedly fitted within the wider path 99, wherein the first leaf L₁⁽³⁾ is thinner than the second leaf L₂⁽³⁾.

The arrangement is such that low rate flow passes through the path 98 deforming the first leaf L₁⁽³⁾ to attain accurate measurement of low flow rates. The higher flow rates are affective through both paths 98 and 99 resulting in deformation of both leaves L₁⁽³⁾ and L₂⁽³⁾ to attain accurate measurement of high flow rates.

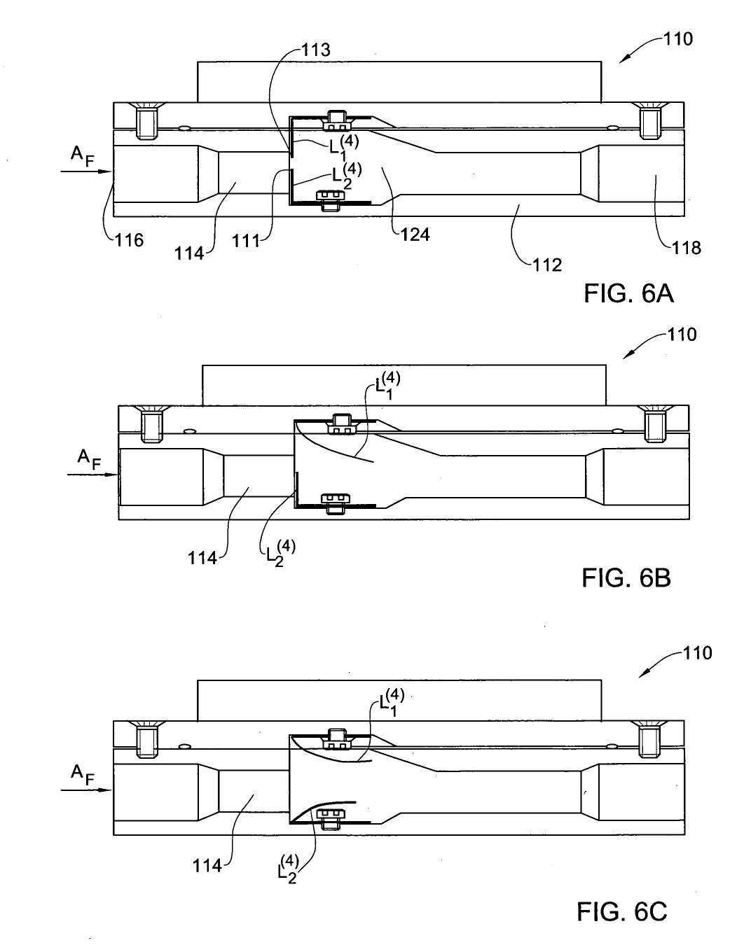

The embodiment illustrated in FIGS. 6A through 6C is concerned with yet another embodiment of the invention illustrating a conduit member 112 a flow meter 110 formed with a conduit 114 extending between an inlet 116 and an outlet 118. The arrangement is such that the conduit 114 is obstructed by a pair of leaves L₁⁽⁴⁾ and L₂⁽⁴⁾ extending co-planar, however each being separately supported to the conduit member 112 and extending towards each other such that their free ends 111 and 113 adjoin one another to obtain substantial obstruction of the fluid path 124.

It can be seen in the drawings that the first leaf L₁⁽⁴⁾ is longer and thinner than the second leaf L₂⁽⁴⁾ thus increasing sensitivity of the first leaf L₁⁽⁴⁾ to low flow rates as opposed to the second leaf L₂⁽⁴⁾ which is substantially insensitive to low flow rate however sensitive to substantially high flow rate.

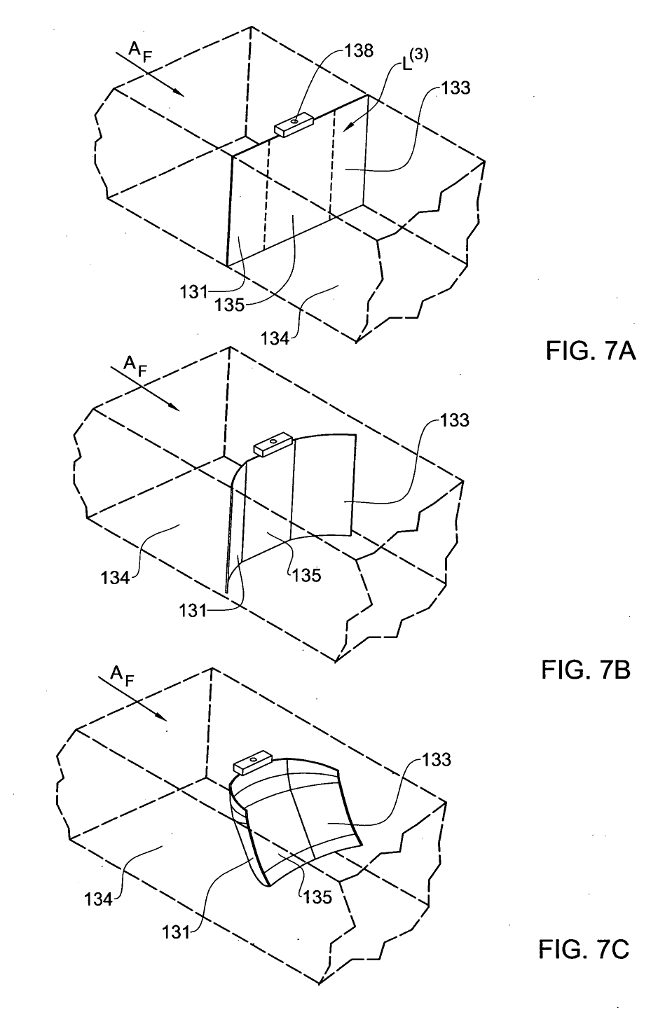

The embodiment of FIGS. 7A and 7B illustrates a conduit 134 constituting a part of a conduit member 137 (not shown). The conduit member 137 may be similar to the conduit member illustrated in FIGS. 4A to 4C. A single leaf L⁽⁵⁾ is fixedly secured to a conduit member 137 by means of fixture 138. The leaf L⁽⁵⁾ is formed such that its elastic properties alter along and across the leaf L⁽⁵⁾ whereby upon initiation of fluid flow through the conduit member 137 the peripheral portions 131 and 133 of the leaf L⁽⁵⁾ which are typically thinner, will deform in a manner facilitating measurement of such deformation so as to determine the flow rate therethrough even at low flow rates. Upon enhancement of the flow through the conduit 134 a central portion 135 of the leaf L⁽⁵⁾ will deform together with the peripheral portions 131 and 133 into the position shown in FIG. 7B.

The extent and deformation pattern of the leaf L⁽⁵⁾ corresponds with the flow rate through the conduit and a signal corresponding with said deformation is generated, indicative of the flow rate.

As already mentioned above, the flow meter according to any of the embodiments of the present invention comprises a measuring system for measuring deformation related pattern of each of the leaves deformed in response to fluid flow within the conduit and generating angle signals corresponding with these angles.

FIG. 8 schematically shows one embodiment of a measuring system 140 comprising an external coil 142 wound around a coil core 144. The external coil 142 generates a variable magnetic filed within a conduit 146. A leaf L is shown in a first state S₁, where, at the absence of flow, the leaf L is perpendicular to the flow axis A, and in a second state S₂, where the leaf L is deflected responsive to the fluid flow. The leaf L is fitted with a leaf coil C mounted thereon. When the flow rate increases and the leaf deflects at an angle α from the first state S₁ to the second state S₂, the voltage in the leaf coil C changes and this change is measured and processed in the microcontroller (not shown) in an electronic circuit 147, which is a part of the main PCB. When the leaves are fixed in series, as shown in the embodiment of FIG. 1, their respective coils C₁ and C₂ do not have mutual induction and each of the voltages, corresponding to a respective angle of a leaf, is measured separately and represents a different r flow rate.

FIG. 9 shows one example of an electronic circuit for use with the measuring systems described above. A microcontroller 151 is connected through an amplifier 153 to the main coil 155. Using the secondary coil 157 and amplifier 159 the signal RMS is converted to DC in the converter 150 and sampled with an A/D converter 152, to the microcontroller 151. The result is calculated with an algorithm that converts the position of the leaf to flow rate. The flow rate is accumulated by time to give a total flow to memory device 154. The flow rate or total flow can be displayed on LCD or transferred to another device throw port 156. Optionally, the information may be transferred through other ports such as 4-20 mA port, frequency port, or RF port.

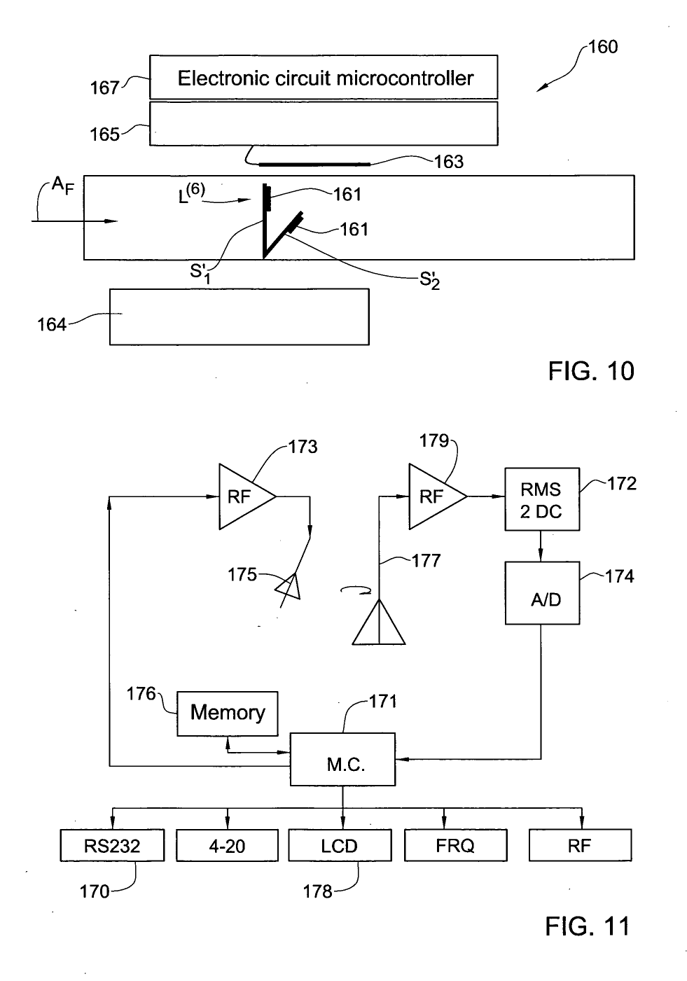

Another embodiment for a measuring system according to the present invention is shown in FIG. 10. A measurement system 160 comprises a first antenna 161 connected to a leaf L⁽⁶⁾ an external antenna 163, an RF transmitter 164, an RF receiver 165 and an electronic microcontroller 167. In operation, the RF transmitter transmits an RF signal to the RF receiver 165 through the leaf L⁽⁶⁾. The deflection of the leaf L⁽⁶⁾ from the position S₁′ to the position S₂′ due to flow through the conduit, deforms the leaf L⁽⁶⁾, together with its associated antenna 161, relatively to the receiver 165. This change effects the transmission intensity of the signal received by the receiver 165, which signal is then converted into flow rate units within the electronic microcontroller 167.

Alternatively, the measuring system 160 may comprise a leaf that itself operates as an antenna.

It is appreciated that in accordance with any of the described embodiments a preliminary step of operation consists of calibration of the rate of deflection of the leaf/leaves and the respective deflection signal with an actual flow rate through the conduit.

FIG. 11 shows one example of an electronic circuit for use within the RF measuring systems described above. A microcontroller 171 is connected to an RF transmitter 173 with an antenna 175 is connected to the transmitter 173. The antenna 175 is attached to a leaf that transmits an RF signal to the fixed antenna outside the flow meter 177. The signal is received by an RF receiver 179. An RMS signal is converted to DC in a converter 172 and sampled with an A/D converter 174, to the microcontroller 171. The result is calculated with an algorithm that converts the position of the leaf to flow rate. The flow rate is accumulated by time to give a total flow to a memory device 176. The flow rate or total flow can be displayed on LCD 178, or transferred to another device through a port 170. Optionally, the information may be transferred through other ports such as 4-20 mA port, frequency port, or RF port. The flow meter may be powered with a battery that is adapted to last for at least ten years.

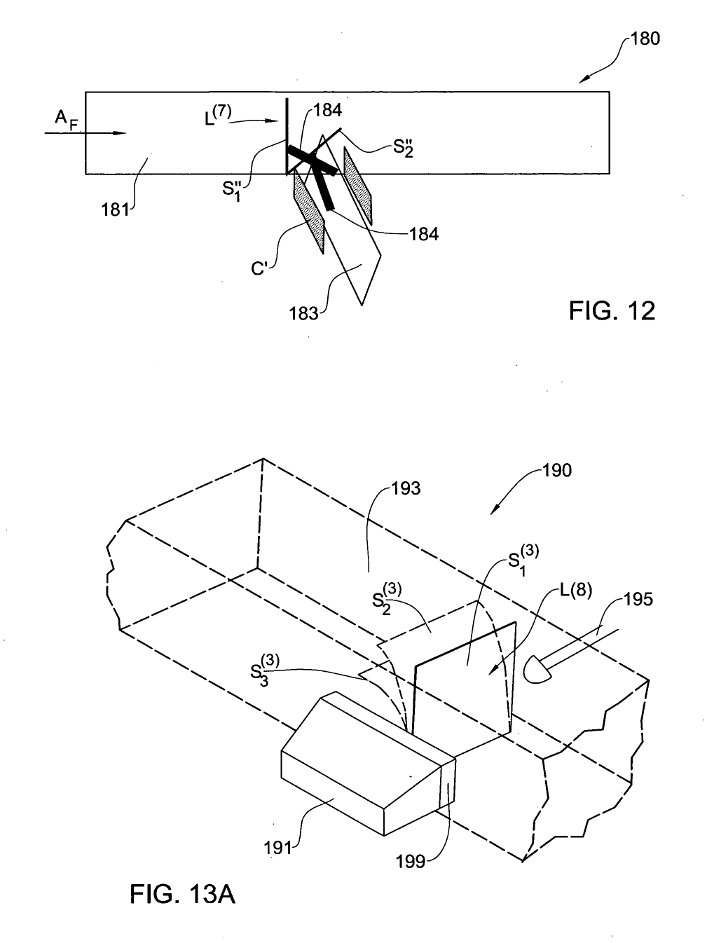

The embodiment of FIG. 12 schematically illustrates a measuring system 180 associated with a main conduit 181 having a branching-off dead ended section 183. A leaf L⁽⁷⁾ has a metal element 184 fixed thereto, which, at the absence of flow (state S₁″), extends outside the section 183. As flow rate increases within the conduit 181, the leaf L⁽⁷⁾ deflects (state S₂″) and the metallic element 184 deflects into the section 183 resulting in voltage changes through an external coil C′ wound about the section 183. This voltage change corresponds to the change in the flow rate within the conduit 181 and may be measured as explained in connection with other embodiments. An advantage of the arrangement is the absence of electrical components within the main conduit 181.

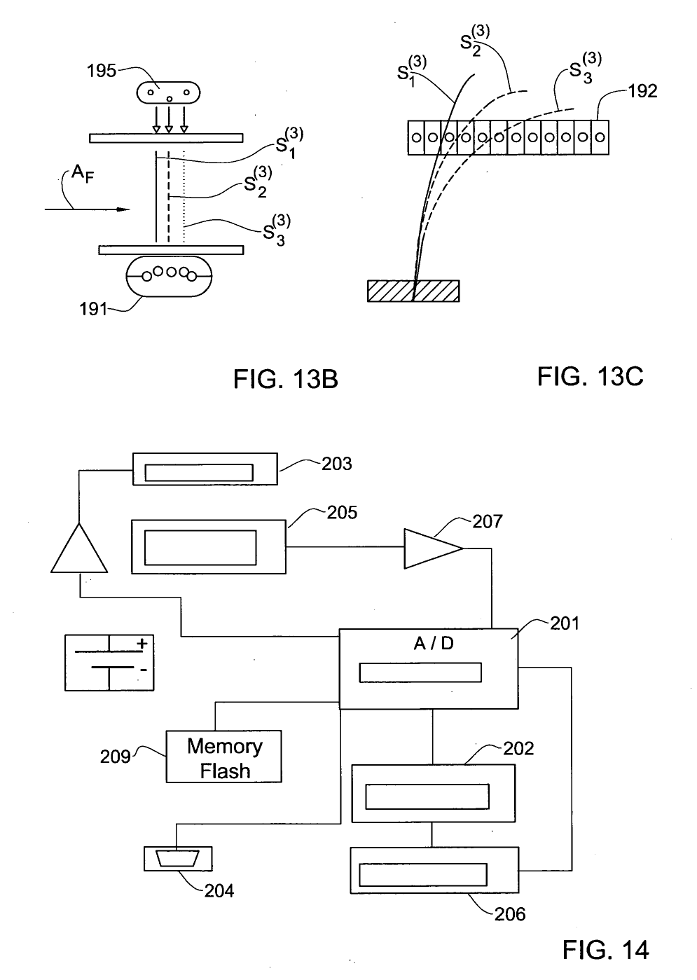

FIGS. 13A to 13C show yet another embodiment of a measuring system according to the present invention. The measuring system 190 comprises a CCD camera 191 fitted with an array of sensors 192 (FIGS. 13A and 13C) extending at one side of the conduit 193. A light source, e.g. LED 195 is fitted at another side of the conduit 193 opposite the sensor array 192. A transparent window 199 extend between the leaf L⁽⁸⁾ and the CCD camera 191.

In operation, when the leaf L⁽⁸⁾ deforms (S₁⁽³⁾ to S₃⁽³⁾) as a result of flow through conduit 193, it partially blocks light emitted by the LED 195 and prevents it from incidence upon certain sensors of the sensors array 192, as shown in FIG. 13C. Consequently, the CCD camera 191 generates a signal corresponding to different angles of the leaf L⁽⁸⁾.

In the present example a linear array of sensors is illustrated. However, it is appreciated that other arrays are possible too, e.g. planar matrixes etc. In such a case a complete representative image of the leaf may be sampled representative of flow rate through the conduit.

The CCD camera 191 has a fine resolution facilitating registration of very small increments of the leaf L⁽⁸⁾. The data received by the CCD camera 191 is processed by a micro-processor (not shown).

Signals associated with the measuring system 190 may be further processed by image processing software and hardware.

FIG. 14 schematically illustrates an electronic circuit for use with a measuring system 200. A microcontroller 201is connected to a LED 203. The image of the leaf is displayed on the CCD 205. Using an amplifier 207 the signal from the CCD 205 is calculated with an algorithm that coverts the position of the leaf indicated by its angle to flow rate. The flow rate is accumulated by time to give a total flow to memory device 209. The flow rate or total flow can be displayed on a digital display 202 or transferred to another device through a port 204. The flow meter is powered with a battery that may last for about ten years. The electronic circuit is connected to a control panel 206 allowing a user to perform a variety of operations such as unit conversion, changing representation options, calibration etc.

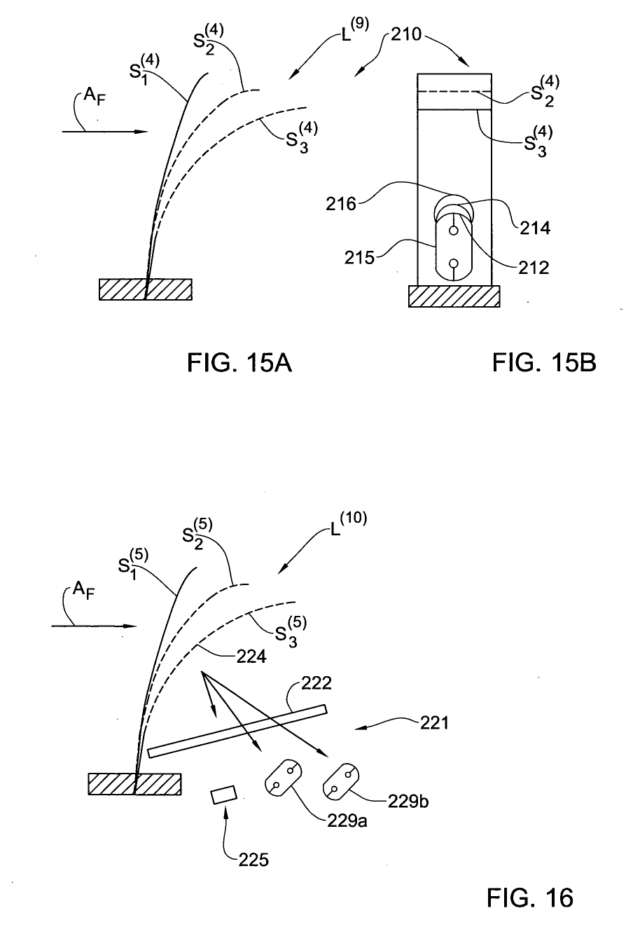

Turning now to FIGS. 15A and 15B, there is illustrated another embodiment of the invention illustrating a measuring system designated 210. Angles of a leaf L⁽⁹⁾ are measured by a strain gage 215 attached to the leaf L⁽⁹⁾. For example, according to states S₁⁽⁴⁾, S₂⁽⁴⁾ and S₃⁽⁴⁾ of the leaf L⁽⁹⁾, the strain gage 215 will strain to positions 212, 214 and 216, respectively, producing thereby corresponding electrical signals, which are then transformed to the controller.

FIG. 16 shows another example of a measuring system according to the present invention. Deflections of a leaf L⁽¹⁰⁾ is measured with a near infrared (NIR) system 221 comprising a NIR transmitter 225 located below the downstream surface 224 of the leaf L⁽¹⁰⁾ and out of the fluid flow, two receivers 229a and 229b and a lens 222. During the movement of the leaf L⁽¹⁰⁾ the NIR signal received by the receivers 229 from the NIR transmitter 225 will change according to the state (for example S₁⁽⁵⁾, S₂⁽⁵⁾ and S₃⁽⁵⁾) of the leaf L⁽¹⁰⁾. When two receivers are provided is relative values are calculated thus external influences such as temperature and transparency of a transparent housing in which the system is mounted may be neglected.

Those skilled in the art to which this invention pertains will readily appreciate that numerous changes, variations and modifications can be made without departing from the scope of the invention mutatis mutandis.

For example, each of the flow meters described above may be combined with each of the measuring systems.

1-23. (canceled)

24. A device for measurement of fluid flow in a conduit comprising:
a housing having an upstream end formed with a fluid inlet, a downstream end formed with a fluid outlet, a fluid flow path extending between the fluid inlet and the fluid outlet and having longitudinal axis;
one or more flexible leaves fixedly mounted within the housing and extending into the fluid flow path, each having a leaf axis normal to a leaf plane, the one or more leaves being deformable responsive to fluid flow rate within the conduit;
a measuring system for measuring a deflection rate of each leaf responsive to fluid flow within the conduit and for generating a rate signal corresponding with the deflection rate; and
a processor unit for processing the rate signal and converting it to an output signal indicative of fluid flow rate within the conduit.

25. The fluid flow measuring device according to claim 24, wherein the deflection rate is a deflection angle measured between the leaf axis and the longitudinal axis.

26. The fluid flow measuring device according to claim 24, wherein each of the one or more leaves is configured to assume at least a first reference state corresponding to a predetermined position with respect to the longitudinal axis, representative of a first fluid flow condition within the conduit.

27. The fluid flow measuring device according to claim 24, wherein deflection rate is a deflection angle and/or deflection pattern of a leaf.

28. The fluid flow measuring device according to claim 24, comprising at least a first leaf having its deflection rate corresponding to a first flow rate and at least a second leaf having its deflection rate corresponding to a second flow rate.

29. The fluid flow measuring device according to claim 28, wherein the first flow rate is substantially low and the second flow rate is substantially high.

30. The fluid flow measuring device according to claim 24, wherein two leafs are provided, a first of which having a first module of elasticity E₁ and the second leaf having a second module of elasticity E₂, wherein E₁<E₂, such that the first leaf is flexible responsive to substantially low flow rates and the second leaf is flexible to substantially high flow rates.

31. The fluid flow measuring device according to claim 24, wherein at least some of the leaves comprise a first portion having first parameters and a second portion having second parameters different from the first parameters by at least one parameter.

32. The fluid flow measuring device according to claim 31, wherein each leaf has a parameter different from parameters of at least part of other leaves by at least one parameter.

33. The fluid flow measuring device according to claim 31, wherein the at least one parameter is selected from the group consisting of an elasticity module, size, shape and a yield point.

34. The fluid flow measuring device according to claim 31, wherein the first portion has a deflection rate corresponding to a substantially high flow rate and the second portion has a deflection rate corresponding to a substantially low flow rate.

35. The device according to claim 24, further comprising at least one leaf support configured for receiving therein of at least one leaf and preventing the leaf from breaking.

36. The fluid flow measuring device according to claim 24, wherein the one or more leaves are mounted in series along the longitudinal axis.

37. The fluid flow measuring device according to claim 24, wherein the leaves are coplanar.

38. The fluid flow measuring device according to claim 24, wherein the leaves are separately supported and are oriented facing each other.

39. The device according to claim 26, wherein the leaf axis in their first reference state is perpendicular to the longitudinal axis of the flow conduit.

40. The fluid flow measuring device according to claim 26, wherein the first reference state corresponds to the absence of flow within the conduit.

41. The fluid flow measuring device according to claim 24, wherein the measuring system comprises an external coil and a leaf coil articulated to each one or more leaf, whereby voltage change is registered as a result of change in the deflection rate of each leaf.

42. The fluid flow measuring device according to claim 24, wherein each leaf is associated with a corresponding coil unit comprising a coil and a corresponding metallic element, the coil unit being external of the fluid flow and the metallic element being attached to the leaf, the coil changing its voltage emittance responsive to induction created by displacement of the metallic element.

43. The fluid flow measuring device according to claim 24, wherein the measuring system comprises at least one of the members selected from the group consisting of an RF transmitter and an RF receiver, a CCD camera adapted for reproducing images of the leaves indicative of their deflection rate, an optical sensor attached to each leaf and adapted for producing a signal indicative of the deflection rate of each leaf and strain gage attached to each leaf and adapted for producing a signal indicative of the deflection rate of each leaf.
